(19) United States
(12) Patent Application Publication
(10) Pub. No.: US 2017/0332846 A1
(43) Pub. Date: Nov. 23, 2017

(54) ATTACHMENT FOR FIXING TO A COOKING UTENSIL

(71) Applicant: BAUMGARTEN HANDLE SYSTEMS KG, Neunkirchen (DE)

(72) Inventor: Ralf Christian BAUMGARTEN, Neunkirchen (DE)

(21) Appl. No.: 15/311,455

(22) PCT Filed: Feb. 4, 2016
(86) PCT No.: PCT/EP2016/052365

§ 371 Date: Nov. 15, 2016

(30) Foreign Application Priority Data
Feb. 11, 2015 (DE) 10 2015 202 428.8

(51) Int. Cl. A47J 45/06; A47J 45/07

(52) U.S. Cl. CPC A47J 45/061; A47J 45/063; A47J 45/071

(57) ABSTRACT

The invention relates to an attachment (1) for handling a cooking utensil, comprising a rigid supporting element (4) which can be fastened directly or indirectly to the cooking utensil, and at least one elastically deformable shaping area (6). In order to ensure that the cooking utensil is fastened securely whilst adapting to the hand of the respective user, the shaping area (6) is formed by a plurality of lamellas (7) which are arranged at a distance to each other.

The invention relates to an attachment for fastening to a cooking utensil, for example a frying pan or a cooking pot or a cooking pot lid, having an add-on piece which can be fastened to the cooking utensil, according to the preamble of claim 1.

Attachments for usage in cooking utensils are known in various embodiments from the state of the art. On the one hand, attachments made completely of metal are used, the add-on piece of such an attachment being attached to the cooking utensil and the handle piece either in one or several welded together parts. Albeit the metallic embodiment bears an advantage regarding how robust and how easy to clean the attachment is, this embodiment is nonetheless connected to a disadvantage regarding the comfortable handling of the cooking utensil. Furthermore, attachments are known from the state of the art which comprise an add-on piece made of a metallic material whereas the handle piece is formed by an injection molded part. This embodiment allows a better ergonomic adjustment to the shape of the hand, thus enabling a comfortable handling of the cooking utensil. Thereby it can be provided, on the one hand, that the handle piece is attached permanently to the add-on part, as can be seen in EP 1 477 096 A1. Likewise, attachments are known from the documents EP 2 249 687 A1 and WO 2012/150192 A1, for example, which comprise a handle piece which can be detached according to its intended use.

Moreover, embodiments are known from the state of the art which comprise an add-on part to be fastened to the cooking utensil which is made completely of a metallic material and also continues as a supporting element within the handle part. For a comfortable handling of the cooking utensil, the supporting element is surrounded by a soft and elastic plastic, so that a certain adjustment to the corresponding shape of the hand can occur when gripping the handle part.

Albeit a comfortable handling of the cooking utensil is already enabled by the aforementioned embodiment, improving the embodiment in regard to a safe and simultaneously comfortable handling of the cooking utensil is still a valid task.

The set task is obtained by the embodiment according to the invention according to the teachings of claim 1.

Advantageous embodiments are subject to the dependent claims.

The generic attachment initially serves for handling a cooking utensil. In this context, the cooking utensil can be, for example, a frying pan or a cooking pot or a cooking pot lid. In which manner the attachment is attached to the cooking utensil is of no importance at first. To start with, the attachment comprises a supporting element which is rigid and enables handling the cooking utensil when gripping the attachment. For this, the supporting element is to be attached directly or indirectly to the cooking utensil.

For comfortable handling, the generic attachment comprises a shaping area which is connected permanently to the supporting element. Due to elastic deforming, an adjustment to the hand of the corresponding user is enabled.

An improvement regarding the known embodiment having a shaping area according to the invention is obtained by implementing a plurality of lamellas, which are distanced to each other, for forming the shaping area. The corresponding lamellas thereby each comprise a bottom end which is directly or indirectly attached to the supporting element. In contrast, the end of the corresponding lamella distanced from the supporting element forms a free end, wherein the free ends of the lamellas are not connected to each other.

By using a plurality of lamellas arranged in a row, an improved adjustment to the hand of the corresponding user is enabled while also ensuring a secure hold of the cooking utensil. Furthermore, the new embodiment of the shaping area enables an exceptional design of the handle part, thus allowing for a characteristic differentiation to the common embodiments of attachments.

Furthermore, it is thereby particularly advantageous for the elastically deformable lamellas to abut to each other in a scalelike manner in the area of the free end when gripping the attachment and when the lamellas are under load.

An advantageous deforming of the lamellas is achieved when they comprise, preferably, a length between 10 mm and 50 mm, starting from the bottom end to the free end. A length of the lamellas between 15 mm and 35 mm is particularly advantageous. Thus, a secure grip, on the one hand, as well as the necessary reshaping of the lamellas is enabled.

Furthermore, under consideration of the handling of the cooking utensil when gripping the attachment, an advantageous grip having a comfortable adjustment via the elasticity of the lamellas is realized when the length of the lamellas increases starting from a first lamella to at least a middle lamella (from the first lamella to a last lamella in the row of consecutive lamellas). This results in a smaller flexibility of the first lamella and a larger flexibility of the middle lamella. It is thereby particularly advantageous when the length of the lamellas increases past the middle lamella to the last lamella. The increasing length of the lamellas serves in particular to change the elasticity of the individual lamellas which consequently increases from the first lamella past the middle lamella to the last lamella.

Under consideration of the deforming of the individual lamellas, an advantageous shaping of the lamellas is realized when they comprise a material thickness between 2 mm and 6 mm at the bottom end, wherein the material thickness is reduced to a thickness between 1 mm and 3 mm towards the free end.

Furthermore, it is advantageous for a comfortable handling when the distance between the lamellas is not too large, but still enables a sufficient elasticity via reshaping of the individual lamellas. This is advantageously ensured when the distance between two lamellas is between 2 mm and 6 mm at the bottom end, wherein the distance between two lamellas is between 1 mm and 3 mm at the bottom end in an unloaded state.

The apparent contradiction between the reduced material thickness from the bottom end to the free end and the reduced distance from the bottom end to the free end is resolved when a particularly advantageous embodiment of the lamellas having a curved design is considered. The lamellas are thereby formed having a curvature arranged between the bottom end and the free end, said curvature being formed to point towards the outer side. Insofar, the lamellas comprise a convex curvature on the mostly outward pointing side, whereas the opposite, mostly concealed side of the lamellas is curved in a convex manner.

Furthermore, it is advantageous when the lamellas are inclined. When looking at curved lamellas, on the one hand, the inclination refers to an imaginary connecting line between the bottom end and the free end of the lamellas. Provided the attachment comprises an oblong shaping along the length of the shaping area, the inclination then refers to an imaginary middle line through the attachment (at least along the length of the shaping area). Provided the attachment already comprises a curved shaping, on the other hand, the inclination then refers to an imaginary tangent at the attachment at each bottom end of the respective lamella. Due to the inclined embodiment of the lamellas in relation to the attachment, the slight deforming of the lamellas when gripping the attachment is enabled.

Moreover, it is particularly advantageous if the inclination of the lamellas increases, starting from the middle lamella to the last lamella, and the orientation of the lamellas thus more and more approaches the orientation of the attachment. Thereby, it is particularly advantageous when the inclination of the lamellas increases, starting from the first lamella to the last lamella.

Different embodiments are available for realizing the shaping area fastened to the supporting element, wherein the advantageous choice can be based on the fastening type of the attachment to the cooking utensil, on the one hand, and on the required surface of the attachment, on the other hand.

For this purpose, it is particularly advantageous in a first embodiment if the supporting element is surrounded by a handle element which integrally encompasses the shaping area. For this purpose, the handle element is produced as a separate part and is then fastened to the supporting element. Since the shaping area is essentially used under load, it is of no importance in this regard that the lamellas are not attached directly to the supporting element with the bottom end but are rather supported at the supporting element. This embodiment is particularly preferred in the cases in which the supporting element is essentially made of a flat sheet metal piece.

In a second embodiment, however, it is particularly advantageous if the shaping area is formed on the supporting element. This embodiment can also be used with a supporting element made of metal. However, this embodiment is preferred in particular in the cases in which the supporting element is made of a plastic injection molded part. Thus, a permanent connection between the rigid supporting element and the elastically deformable shaping area can be realized in a two-component method.

When implementing the second embodiment, it is possible, on the one hand, to limit the area formed by an elastically deformable material to the lamellas. On the other hand, further areas of the supporting element can also be overmolded by the elastically deformable material, so that a surface closed on the visible side, for example, can be realized from the elastically deformable material (and thus corresponds to the appearance of the mounted handle element).

When used as a handle for cooking pot lid, for example, it can be provided that the supporting element is fastened directly to the cooking pot lid. For this purpose the supporting element is generally provided with a thread bore on the lower side, so that a fastening can take place by means of a screw which engages through the lid.

The usage as a handle for a lid generally requires add-on parts on both sides, said add-on parts being able to be fastened to the cooking pot. The manner in which the add-on part is fastened is of no importance regarding the realization of the invention. The add-on part can be fastened, for example, via welding, soldering or riveting. At least in these cases, an add-on part is generally used in which the supporting element is connected permanently to the add-on parts, wherein an embodiment of integrally formed supporting elements having add-on parts can generally be found as well. However, the attachment can also be realized by adding an add-on part to both ends of the supporting element.

When using the attachment for a frying pan, for example, the attachment generally comprises an add-on part which is fastened to the frying pan. In this case, in turn, it is of no importance whether the intended fastening of the attachment to the frying pan occurs via welding, soldering or riveting. Likewise, as in the embodiment of attachments for cooking pots having two add-on parts, embodiments are possible in which the add-on part is connected permanently to the supporting element. For this purpose, it can simultaneously be provided that the supporting element and the add-on part are formed integrally or that alternatively the supporting element (for example after fastening the add-on part to the cooking utensil) is fastened to the add-on part.

In contrast to the usage of the handle for cooking pots having two permanently connected add-on parts, embodiments are also possible in which the supporting element can be detached from the add-on part by the user of the cooking utensil. In this embodiment, the supporting element and the shaping area form a supporting part which can be attached to or detached from the add-on part belonging to the attachment by the user when necessary.

Regarding the arrangement of the shaping area, it is particularly advantageous if the shaping area is arranged on the lower side of the supporting element when using the attachment for a cooking pot, a frying pan or similar. Thus, a secure grip of the cooking utensil when gripping the handle part is achieved along with a comfortable adjustment to the hand of the corresponding user.

Furthermore, it is particularly advantageous when using the attachment having an individual add-on part, meaning generally for a frying pan or similar, if the free ends are pointing away from the add-on part when the lamellas are inclined.

In the following figures, two exemplary embodiments are shown for an attachment according to the invention.

In the Figures

FIG. 1 shows a perspective view on a first embodiment of an attachment without a detachable handle part;

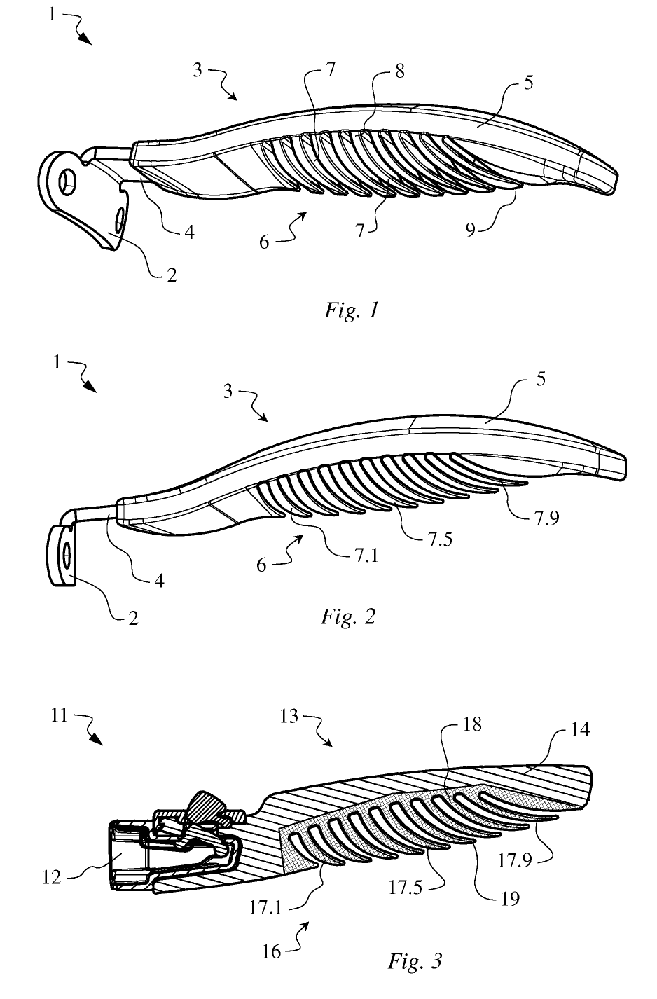

FIG. 2 shows a side view of the embodiment according to FIG. 1;

FIG. 3 shows an alternative embodiment of an attachment having a detachable handle part;

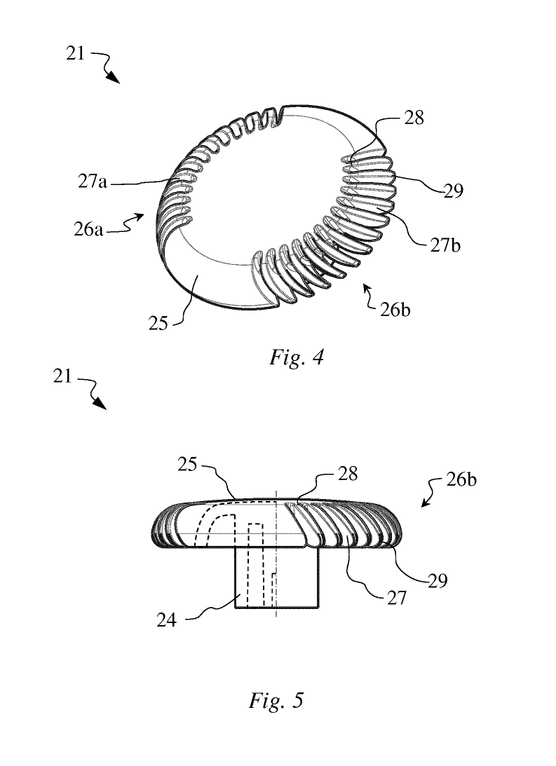

FIG. 4 shows a perspective view on an embodiment using the attachment as a handle for a cooking pot lid;

FIG. 5 shows a side view of the embodiment according to FIG. 4.

In FIG. 1, a perspective view on a first exemplary embodiment of an attachment according to the invention is outlined. For this purpose, FIG. 2 shows the same embodiment in FIG. 1. First, the add-on part 2 can be seen which is intended to be fastened to the cooking utensil. In this embodiment, the supporting element 4 is integrally connected to the add-on part 2, said supporting element 4 essentially extending over the entire length of the handle part 3. For this purpose, the supporting element 4 of the handle part 3 is covered by a handle element 5, so that only the base of the supporting element 4 pointing towards the add-on part 2 is visible to the user (and can be seen in the Figures). An advantageous shaping for comfortably handling the cooking utensil is realized by means of the handle element 5.

The shaping area 6 according to the invention is now realized by implementing a plurality of lamellas 7. These lamellas 7 are each fastened to a bottom end 8 at the supporting element 4. In comparison, the individual lamellas 7 comprise a free end 9 at which 9 the lamellas 7 are not connected to each other. Thus, the individual lamellas 7 can be formed flexibly to each other. The realization of the shaping area 6 having the flexible lamellas 7 occurs in this embodiment via the integrally formed handle element 5 which covers the supporting element 4 on the one hand and also integrally forms the shaping area 6.

Moreover, it can be seen that the individual lamellas 7 comprise a curved shape, wherein the curvature points in direction of the add-on part 2, meaning away from the handle part. Additionally, it can be seen, in particularly in FIG. 2, that the length of the individual lamellas increases, starting from the first lamella 7.1, which is closest to the add-on part 2, over the middle lamella 7.5 to the last lamella 7.9. Furthermore, the inclination of the individual lamellas 7 is increased, also starting from the first lamella 7.1 past the middle lamella 7.5 to the last lamella 7.9 in relation to the position of the handle part 3, wherein the lamellas 7 correspondingly approach the orientation of the handle part 3 with increasing distance to the add-on part 2.

An alternative embodiment for an attachment 11 according to the invention is outlined in FIG. 3. In contrast to the afore-described embodiment, the handle part 3 can now be detached from the add-on part 12. For this purpose, a rigid supporting element 14 is applied to the handle part 13. This supporting element 14 can be produced as a high pressure die cast part or, particularly advantageously, as a plastic injection molded part and can thus be adjusted to an ergonomic shaping.

In order to realize a shaping area 16, a plurality of lamellas 17 are arranged at the supporting element 14 on the bottom of the grip part 13, said lamellas 17 being directly injected in this embodiment. Thus, on the one hand, a simple and advantageous production is enabled while an advantageous grip is also ensured. The same method as described above applies to the lamellas 17 regarding the orientation and shaping of the lamellas. The individual lamellas 17 are also fastened to a foot end 18 at the supporting part 14 while the free end 19 of the corresponding lamellas are not connected to each other. Likewise, the length of the individual lamellas as well as the inclination of the lamellas is increased, starting from the lamella 17.1, closest to the add-on part 12, past the middle lamellas 17.5 to the last lamella 17.9.

In FIG. 4, a further embodiment of an attachment 21 is shown, wherein this attachment 21 is outlined in a side view in FIG. 5. The round shape of the attachment 21 can be seen, said attachment 21 being intended for use in particular as a handle for a cooking pot lid. The attachment is formed by a rigid supporting element 24 on the lower side, said supporting element 24 being advantageously realized as a plastic injection molding part for this purpose. The supporting element 24 can be fastened directly to the cooking pot lid by means of a screw. On the upper side, the supporting element 24 is covered by a handle element 25 which 25 in this case is integrally injected on the supporting element 24. For this purpose, the handle element 25 encompasses the two shaping areas 26a and 26b which face away from each other.

Each of the shaping areas is formed by a plurality of consecutive lamellas 27a, 27b which 27, in turn, are fastened to a bottom end 28 at the supporting element 24. In contrast to this, the ends of the lamellas 27 on opposite sides of the bottom end 28 each form a free end 29 at which 29 these lamellas 27 are not connected to each other. Same as in the preceding example, the lamellas 27 comprise a curved shaping which points away from the supporting element 24. Likewise, the lamellas 27 are inclined relative to a tangent at the supporting element 24.

1. An attachment (1, 11, 21) for handling a cooking utensil, comprising a rigid supporting element (4, 14) which (4, 14) can be fastened directly or indirectly to the cooking utensil, and at least one elastically deformable shaping area (6, 16, 26a, 26b) arranged at the supporting element (4, 14),
characterized in that
the shaping area (6, 16, 26a, 26b) is formed by a plurality of lamellas (7, 17, 27a, 27b) which (7, 17, 27a, 27b) are arranged at a distance to each other and are fastened directly or indirectly at the supporting element (4, 14) with a bottom end (8, 18, 28) and comprise a free end (9, 19, 29) arranged at a distance to the supporting element (4, 14).

2. The attachment (1, 11, 21) according to claim 1,
characterized in that
the lamellas (7, 17, 27) abut against each other in a scalelike manner at least in the area of the free end (9, 19, 29) upon loading.

3. The attachment (1, 11, 21) according to claim 1,
characterized in that
the length of the lamellas (7, 17, 27) is between 10 mm, in particular 15 mm, and 50 mm, in particular 35 mm, from the bottom end (8, 18, 28) to the free end (9, 19, 29).

4. The attachment (1, 11, 21) according to claim 1,
characterized in that
starting from a first lamella (7.1, 17.1) at least to the middle lamella (7.5, 17.5), in particular to the last lamella (7.9, 17.9), the length of the consecutive lamellas (7, 17) increases.

5. The attachment (1, 11, 21) according to claim 1,
characterized in that
the lamellas (7, 17, 27) at the bottom end (8, 18, 28) have a material thickness between 2 mm and 6 mm, wherein the material thickness is reduced to 1 mm to 3 mm towards the free end (9, 19, 29).

6. The attachment (1, 11, 21) according to claim 1,
characterized in that
the distance between two lamellas (7, 17, 27) at the bottom end (8, 18, 28) is between 2 mm and 6 mm, wherein the distance between two lamellas (7, 17, 27) at the free end (9, 19, 29) is between 1 mm to 3 mm when unloaded.

7. The attachment (1, 11, 21) according to claim 1,
characterized in that
the lamellas (7, 17, 27) between the bottom end (8, 18, 28) and the free end (9, 19, 29) are curved outward.

8. The attachment (1, 11, 21) according to claim 1,
characterized in that
the lamellas (7, 17, 27) are inclined.

9. The attachment (1, 11) according to claim 8,
characterized in that
the inclination of the consecutive lamellas (7, 17) increases starting from at least the middle lamella (7.5, 17.5), in particular from the first lamella (7.1, 17.1), to the last lamella (7.9, 17.9).

10. The attachment (1) according to claim 1,
characterized in that
the supporting element (4) is surrounded by a handle element (5) fastened thereon (4), which (5) integrally encompasses the shaping area (6).

11. The attachment (11, 21) according to claim 1,
characterized in that
the supporting element (14) is an injection molded part, wherein the lamellas (12) are injected onto the supporting element (14); or
that the supporting element (14) is an injection molded part, wherein the supporting element (24) is surrounded by a handle element (25) applied thereon (24) via an injection molding process, said handle element (25) integrally encompassing the shaping area (26).

12. The attachment (1, 11) according to claim 1,
characterized in that
at least one add-on part (2, 12) is arranged at the supporting element (4, 14), said add-on part (2, 12) being able to be attached detachably or permanently to the cooking utensil.

13. The attachment (1, 11) according to claim 12,
characterized in that
the lamellas (7, 17) are arranged pointing away from the add-on piece (02, 12) with their (7, 17) free ends (9, 19).
